(19) United States
(12) Patent Application Publication
(10) Pub. No.: US 2015/0100696 A1
(43) Pub. Date: Apr. 9, 2015

(54) COMMUNICATION SYSTEM, CONVERGED COMMUNICATION NODE, AND METHOD FOR SUPPORTING CLOUD SERVICE

(71) Applicant: Electronics and Telecommunications Research Institute, Daejeon (KR)

(72) Inventors: Sang-Min LEE, Daejeon (KR); Bhum Cheol LEE, Daejeon (KR); Jung Hee LEE, Daejeon (KR); Young Ho PARK, Daejeon (KR); Kang Il CHOI, Daejeon (KR); Seung-Woo LEE, Daejeon (KR)

(73) Assignee: Electronics and Telecommunications Research Institute, Daejeon (KR)

(21) Appl. No.: 14/247,490

(22) Filed: Apr. 8, 2014

(30) Foreign Application Priority Data
Oct. 4, 2013 (KR) 10-2013-0118660

(51) Int. Cl. H04L 12/24

(52) U.S. Cl. CPC H04L 41/50
USPC 709/226

(57) ABSTRACT

A communication system for supporting a cloud service comprising: a communication node connected to a network; an IDC connected to the network; a converged communication apparatus connected to the network and configured to interact with the IDC to integrally manage a resource stored in the IDC, and, upon a receipt of a request for the cloud service, to interact with the communication node to transfer the resource to a user who makes the cloud service request or a service provider which makes the cloud service request.

### RELATED APPLICATIONS

This application claims the benefit of Korean Patent Application No. 10-2013-0118660, filed on Oct. 4, 2013, which is hereby incorporated by reference as if fully set forth herein.

### FIELD OF THE INVENTION

The present invention relates to a communication node and a communication network for supporting a cloud service, and more particularly, to a communication system, a converged communication node and a method for supporting a cloud service which support the cloud service of several service providers using a single node in cooperation with a communication node and an IDC (Internet Data Center), such that the cloud service of the service providers can be smoothly supported and the cloud service can be easily provided using an available communication node without building up or supplementing new physical environment.

### BACKGROUND OF THE INVENTION

In recent years, there is an increasing demand for cloud services using mobile terminals with the rapid growth of mobile communication industry, for example, particularly, smart-phone and smart-pad market. A cloud service refers to a service that stores various types of content in servers on the Internet and enables users to utilize this content in any place using various types of terminals.

The cloud service has resulted in increased network traffic due to the increase in data capacity. In particular, the cloud service causes an increase of users who enjoy video services using various Internet access devices. An increase of users who use relatively large amounts of video content adversely affects the quality of the network, and an effort is required to improve this adverse effect is required.

In an effort to solve the problem on network load due to an increase of mass traffic such as the video content service, a CDN (Content Delivery Network) service is proposed to balance the network traffic that is concentrated in a small number of servers. In order to prevent the traffic from being concentrated to a web server of a CP (Content Provider) which is relatively far away from the user, the CDN service deploys servers at POP (Point of Presence) of an ISP (Internet Service Provider) and provides users with high-capacity content or frequently used content through the servers.

This CDN service provides advantages that enables the provision of a smooth service through the distributed servers even in a case of network failure or the network congestion by users in terms of the CP and enables the reduction of the amount of traffic directed to the server in terms of the ISP since the content are serviced through the server located at a distance close to the user from an ISP standpoint.

However, in the CDN service, the cloud service is provided by cloud service providers in the form of installing their servers and network facilities on an existing communication node. Further, since the individual cloud service providers separately install and manage their own facilities, the Internet service provider simply accommodates a space for the servers of the cloud service providers or content service providers and leases a resource of ports that are connected to the servers, but does not get involved in the management and control of the related facilities and resources. In addition, since the cloud service providers need to install their facilities on communication nodes necessary for a smooth service, they encounter the difficulty of management and overlapping investment.

In other words, all cloud service providers install their own servers on the network of the Internet service provider according to their needs. Thus, the individual facilities of different service providers are installed and managed independently, which hinders an integrated management and results in a problem of overlapping investment. In addition, although the installation of these facilities causes an increase of network load, the Internet service provider cannot obtain revenue other than the rent of the space and some of the communication ports, and the facilities that are installed intricately by the different cloud service providers incurs an increase of the complex management.

FIG. 1 is a conceptual diagram showing a network on which communication nodes 110 and IDCs (Internet Data Centers) 100 are connected.

Referring to FIG. 1, each of the IDCs 100 may be owned by a service provider providing an Internet service or a cloud service provider having the purpose of providing a cloud service. Now, it is assumed that the cloud service provider owns the IDC 100. Such an assumption is also applicable even if the IDC 100 of the cloud service provider is logically divided for separate use. That is, three IDCs A, B, and C may be physically separated for use in three different cloud service providers, or one IDC may be logically divided into three logical parts.

FIG. 2 is a conceptual diagram of a CDN network in which CDN servers are added for a CDN service to FIG. 1.

Referring to FIG. 2, the CDN network includes a core network and a plurality of IDCs 200 for cloud service providers different from one another. A plurality of CDN servers 230, 232, 234 for the respective cloud service providers are connected to a communication node 210 which is connected to the core network. Each of the servers 230, 232, 234 will operate independently under a control/management of each corresponding cloud service provider. For the CDN service, the CDN servers for each provider which are connected to the communication node saves the high-capacity content or the frequently used content, and the content is delivered to the user through a server located at the shortest distance if there is the user's request.

To put it another way, as shown in FIG. 2, in the CDN network, the servers 230, 232, 234 of different three cloud service providers are connected to the communication node 210 that is a facility of the Internet service provider. The three CDN servers 230, 232, 234, which are content servers A′, B′, and C′, that are respectively relevant to the IDCs A, B, and C are independent from one another and transfer a predetermined amount of data by assigning with the communication ports of the communication node.

However, as described above, since each server is operated independently for each cloud service provider, even if a cloud service provider A has an insufficient storage capacity or has a low link capacity, the cloud service provider A cannot use resources of a cloud service provider B that is idle. Therefore, the cloud service provider A should expand additional servers or secure additional communication ports to solve its resource shortage problem. In such a configuration of the CDN network, the CDN servers that are connected to the communication node are controlled and managed by the cloud service providers, and the Internet service provider that is responsible for managing the communication node plays only a role to lease the space for the installation of the CDN servers and the communication ports of the communication node.

Thus, for the Internet service provider, the load on the network may increase due to the traffic from the content service provider, which leads to additional network costs, but the Internet service providers will get a limited profit.

### SUMMARY OF THE INVENTION

In view of the above, the present invention provides a method for performing an integrated management of network facilities, communication resources, and computing resources to efficiently distribute the resources to different cloud service providers.

Further, the present invention provides a converged communication apparatus, which serves as a communication node connected to a communication network to support a cloud service, including an IDC, a communication node, and a computing server interworking with the IDC and the communication node.

Further, the present invention provides a communication system, converged communication apparatus and method for supporting a cloud service of different cloud service providers through a single node interacting with a communication node and an IDC, thereby smoothly supporting the cloud service of different cloud service providers and easily supporting the cloud service without additionally building up or supplementing a new physical environment even in a case of the change in the service environment.

In accordance with a first embodiment of the present invention, there is provided a method for communication system for supporting a cloud service comprising: a communication node connected to a network; an IDC connected to the network; and a converged communication apparatus connected to the network and configured to interact with the IDC to integrally manage a resource stored in the IDC, and, upon a receipt of a request for the cloud service, to interact with the communication node to transfer the resource to a user who makes the cloud service request or a service provider which makes the cloud service request.

In accordance with a second embodiment of the present invention, there is provided a converged communication apparatus for supporting a cloud service comprising: a network connectivity device configured to interact with an IDC and a plurality of communication nodes on a network to transfer data necessary for the cloud service; and a local data center connected to the network through eh network connectivity device and configured to interact with the IDC to integrally manage a resource stored in the IDC, and, upon a receipt of a request for the cloud service, to transfer the resource corresponding to the cloud service request to a user who makes the cloud service request or a service provider which makes the cloud service request through the network connectivity device.

In the embodiment, the local data center comprises: a virtual server of a service provider configured to provide the cloud service using the resource to the user connected to the network; and a storage that stores the resource necessary for the cloud service.

In the embodiment, the virtual server comprises: a combined resource virtualization unit configured to virtual the resource stored in the IDC; a service provider management unit configured to perform a control and management on a service provider basis on the virtualized resource; and a service broker unit configured to interact with the IDC and the communication node to relay the cloud service of the resource.

In the embodiment, the resource includes a multimedia content.

In the embodiment, the network connectivity device includes a router or a switch.

In accordance with a third embodiment of the present invention, there is provided a method for supporting a cloud service comprising: interacting with an IDC and a plurality of communication nodes on a network to receive a request for a cloud service; interacting with the IDC to integrally manage a resource stored in the IDC; and, upon a receipt of the request for the cloud service through the network, transferring the resource corresponding to the cloud service request to a user who makes the cloud service request or a service provider which makes the cloud service request through the network.

In the embodiment, said interacting with the IDC to integrally manage resource comprises: virtualizing the resource stored in the IDC; performing a control and management on a service provider basis on the virtualized resource; and interacting with the IDC and the communication nodes to relay the cloud service of the resource.

In accordance with a fourth embodiment of the present invention, there is provided a method for supporting a cloud service comprising: receiving a request for the cloud service through a communication node on a wire/wireless network; and transferring the cloud service request to an IDC which is connected to the network and used to provide the cloud service; transferring the cloud service request to a converged communication unit which manages the resource and is optimal for performing the cloud service request; and transmitting the resource corresponding to the cloud service request to a user who makes the cloud service request or a service provider which makes the cloud service request.

In accordance with the embodiments of the present invention, the cloud service of several service providers is supported using the single node interacting with the communication node and the IDC. Accordingly, it is possible that the cloud service of the service providers can be smoothly supported and the cloud service can be easily provided using the converged communication apparatus without newly building up or supplementing a physical environment of the network even in a case of the change in a network environment or the adventure of new application services.

Further, it is beneficial in terms of the integrated management of the network that the Internet service provider directly installs and integrally manages the facilities for the cloud service and leases the relevant computing resources. Furthermore, it is beneficial for the content providers that they directly install and manage their facilities to reduce a cost and use the existing service equally as before.

Further, since such an integrated management of the network enables the analysis of an optimal communication route and an optimal computing resource, it is possible to increase the efficiency of the network and computing resource to provide a high-quality service.

In addition, the converged communication apparatus can support the integrated resource virtualization, a multitenant control and management function, a service relay function for the IDC, and packet switching and routing functions. Therefore, it is possible to rapidly and efficiently provide the computing and communication resource necessary for the cloud service providers.

### BRIEF DESCRIPTION OF THE DRAWINGS

The above and other objects and features of the present invention will become apparent from the following description of the embodiments given in conjunction with the accompanying drawings, in which:

FIG. 1 is a network diagram of a communication system for supporting a cloud service in accordance with a related art;

FIG. 2 is a network diagram of a communication system for supporting a cloud service using a CDN server in accordance with a related art;

FIG. 3 is a network diagram of a communication system for supporting a cloud service including a converged communication apparatus in accordance with an embodiment of the present invention;

FIG. 4 is a block diagram of the converged communication apparatus shown in FIG. 3 in accordance with an embodiment of the present invention;

FIG. 5 is a functional block diagram of a virtual server in accordance with an embodiment of the present invention;

FIGS. 6A and 6B are conceptual diagrams of communication between virtual machines in the virtual server of the converged communication apparatus and between virtual machines in different virtual servers in accordance with an embodiment of the present invention; and

FIG. 7 is a conceptual diagram of a process carrying out the cloud service in accordance with an embodiment of the present invention.

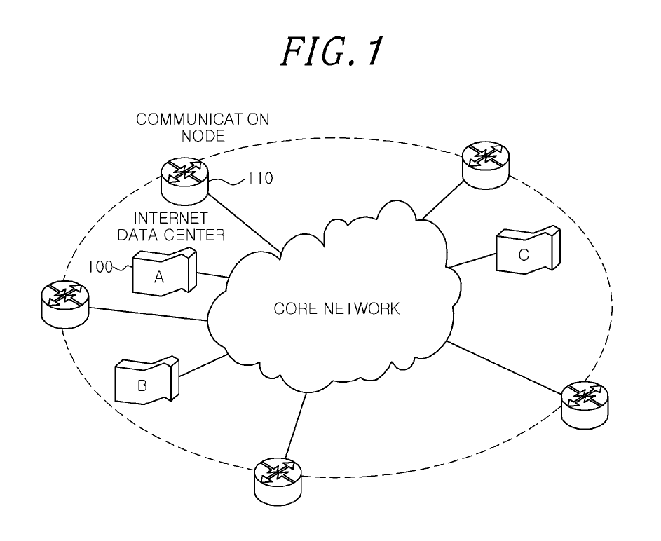

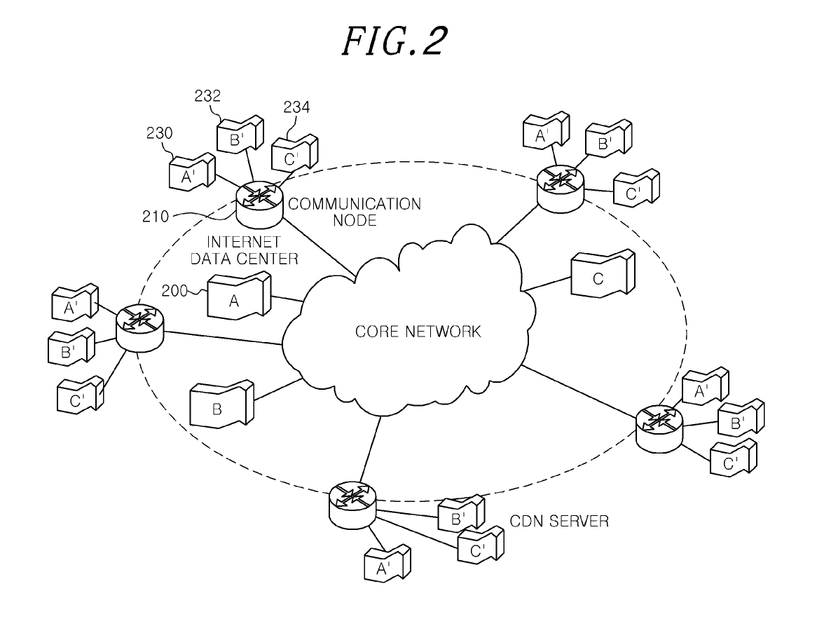

### DETAILED DESCRIPTION OF THE EMBODIMENTS

Hereinafter, the embodiments of the present invention will be described in detail with reference to the accompanying drawings. In the following description, well-known functions or constitutions will not be described in detail if they would unnecessarily obscure the embodiments of the invention. Further, the terminologies to be described below are defined in consideration of functions in the invention and may vary depending on a user's or operator's intention or practice. Accordingly, the definition may be made on a basis of the content throughout the specification.

The embodiment of the present invention proposes a topology of a communication system for supporting a cloud service, which includes an IDC, a communication node, and a converged communication apparatus interacting with the IDC and the communication node in order to remove the problem on the management that occurs when servers are independently installed for each cloud service provider and to establish an optimal network route and an optimal resource use.

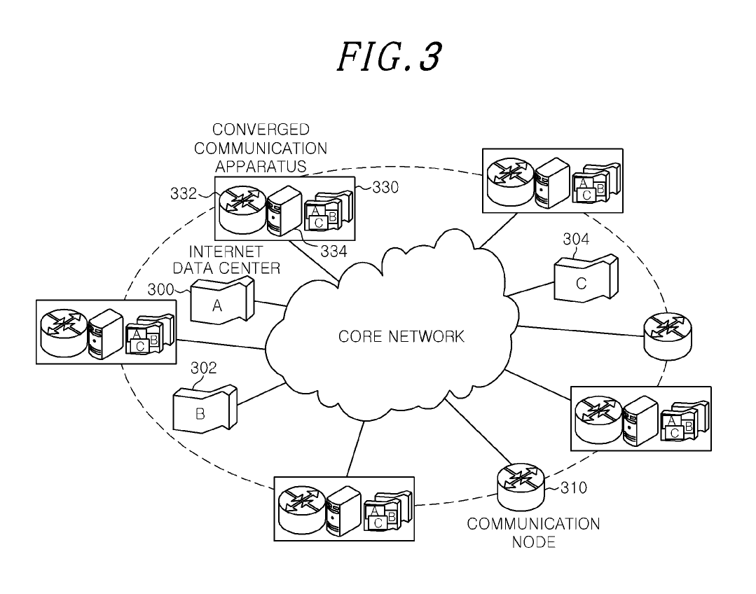

FIG. 3 is a network diagram of a communication system for supporting a cloud service including a converged communication apparatus in accordance with an embodiment of the present invention.

Referring to FIG. 3, a communication system for a cloud service includes a plurality of the IDCs, for example, three IDCs 300, 302, 304 and a plurality of converged communication apparatuses 330.

Each of the converged communication apparatuses 330 has a computing function embedded therein and includes a server or virtual server to manage content in the IDCs 300, 302, 304 that are also respectively referred to as A, B, and C and storage 334. The converged communication apparatus 330 further includes a network connectivity unit 332 through which it is connected to a core network to interact with the IDCs 300, 302, 304 and a communication node 310.

In other words, the converged communication apparatus 330 interacts with the IDCs 300, 302, 304 that are connected to the core network and the communication node 310 that may be a router or switch connected to an access network.

Also, the converged communication apparatus 330 integrally manages the resources of the IDCs 300, 302, 304 by interacting with the communication node 310 and the IDCs 300, 302, 304 and provides a virtualization function on the resources that are managed integrally. Further, the converged communication apparatus 330 performs a multitenant control function and a multitenant management function on the integrally managed resources. Furthermore, the converged communication apparatus 330 also serves as a service broker to relay the connection to the IDCs 300, 302, 304 by interacting with the IDCs 300, 302, 304 and the communication node 310. In addition, the converged communication apparatus 330 interacts with the communication node 310 through the network connectivity device 332 to perform a communication function such as routing and switching functions.

In general, a virtualization is a technology of improving utilization efficiency of physical resources by making different systems as if they are one system or logically dividing one physical system into several systems for use them.

The virtualization function of the integrated communication apparatus 330 integrates resources of communication nodes 310 and IDCs 300, 302, 304 that are physically distributed over the network and logically divides the resources into several portions to use the divided resources on a service provider bases or on a user basis. Accordingly, this virtualization enables to flexibly separate the computing resource embedded in the converged communication apparatus 330 or the like into different service providers and integrally manage the resources that are separated in conjunction with the IDC.

As set forth above, because a CDN network of a related art has a structure in which servers are individually deployed on a service provider basis and managed by their corresponding service providers and the resources of several service providers connected to a communication node do not share with the other service providers, an integrated resource management could not be implemented and resource efficiency was also lowered.

The embodiment of the present invention intends to improve the management efficiency and the resource management efficiency through the integrated management and the virtualization of the integrated resources wherein multitenant control and management functions are supported for the resource virtualization.

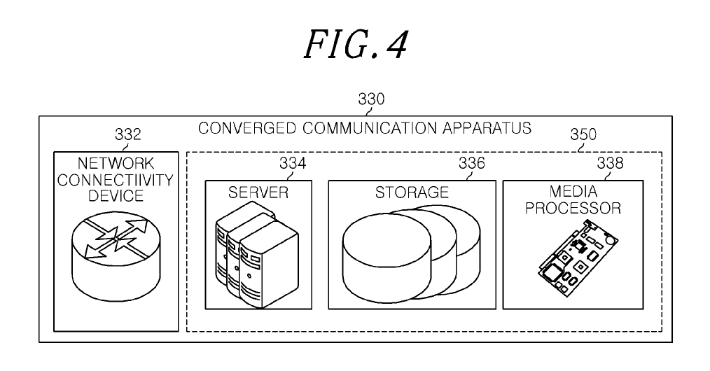

FIG. 4 is a detailed block diagram of the converged communication apparatus shown in FIG. 3 in accordance with an embodiment of the present invention.

Referring to FIG. 4, the converged communication apparatus 330 includes a local data center 350 and a network connectivity device 332, e.g., such as a router or switch, that are combined together. The local data center 350 includes a virtual server 334, a storage 336, and a media processor 338.

The mixed communication apparatus 330 interacts with the IDCs 300, 302, 304 and the communication node 310. In particular, the converged communication apparatus 330 has the capability of interacting with ToR (Top of Rack) switch and serves as a service broker of the IDC. Further, the converged communication apparatus 330 by itself can play a role of a local IDC. In addition, the converged communication apparatus 330 is capable of performing routing and switching functions through the use of the network connectivity device 332, which enables the replacement of the communication node.

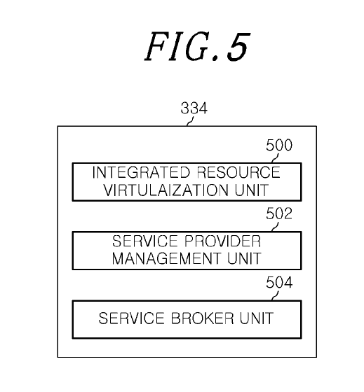

FIG. 5 is a detailed functional block diagram of the virtual server 334 in the converged communication apparatus. The virtual server 334 includes a resource virtualization unit 500, a service provider management unit 502, and a service broker unit 504.

The resource virtualization unit 500 virtualizes the resource stored in the IDCs 300, 302, 304. The service provider management unit 502 performs a control and management of the virtualized resource. The service broker unit 504 interacts with the IDCs 300, 302, 304 and the communication node 310 to relay the cloud service of the integrally managed resource.

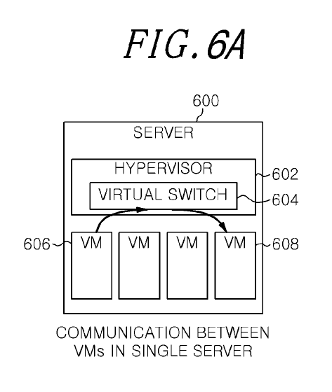

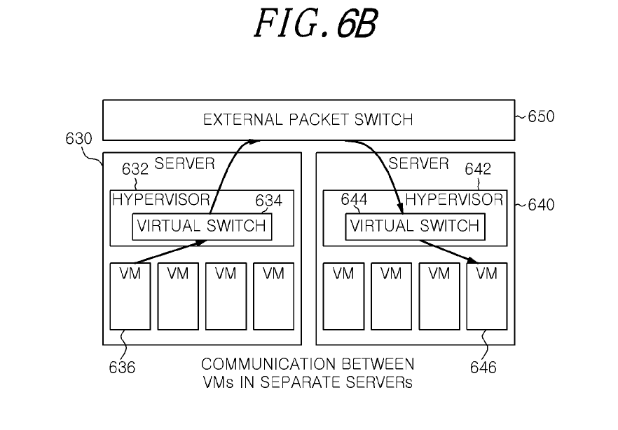

FIGS. 6A and 6B are conceptual diagrams of communication between virtual machines in the virtual server of the converged communication apparatus and between virtual machines in different virtual servers.

Referring to FIGS. 6A and 6B, a virtual server 600 in the converged communication apparatus includes a hypervisor 602 and a plurality of virtual machines (VM) 606 and 608. The communication between the virtual machines 606 and 608 in a single server is achieved by use of a virtual switch 604 as shown in FIG. 6A, and the communication between virtual machines 630 and 640 that are dispersed physically is achieved by use of virtual switches 634, 646 of hypervisors 632, 642 in virtual servers 630, 640, respectively, via an external packet switch 650, as shown in FIG. 6B.

FIG. 6A shows a communication scheme between the virtual machines 606 and 608 in a single virtual server using the virtual switch 604 in the hypervisor 602.

FIG. 6B shows a communication scheme between the virtual machines 636 and 646 in the separate servers 630 and 640. In this communication scheme, the virtual machine 636 of the hypervisor 632 in a transmitting side determines that any virtual machine does not exist in the virtual server 630 and sends a relevant notice indicative of the absence of the virtual machine to the packet switch 650. In response thereto, the external packet switch 650 transfers the relevant notice to the virtual server 640, and the virtual switch 644 then forwards the notice to the virtual machine 646.

In this regard, the virtual switch and the external packet switch may be implemented with a variety of switches such as a flow-based virtual switch and a flow-based packet switch. When being implemented with the flow-based virtual switch and the flow-based packet switch, it will be expected that network transfer efficiency can be increased through the packet transfer ability in a flow unit.

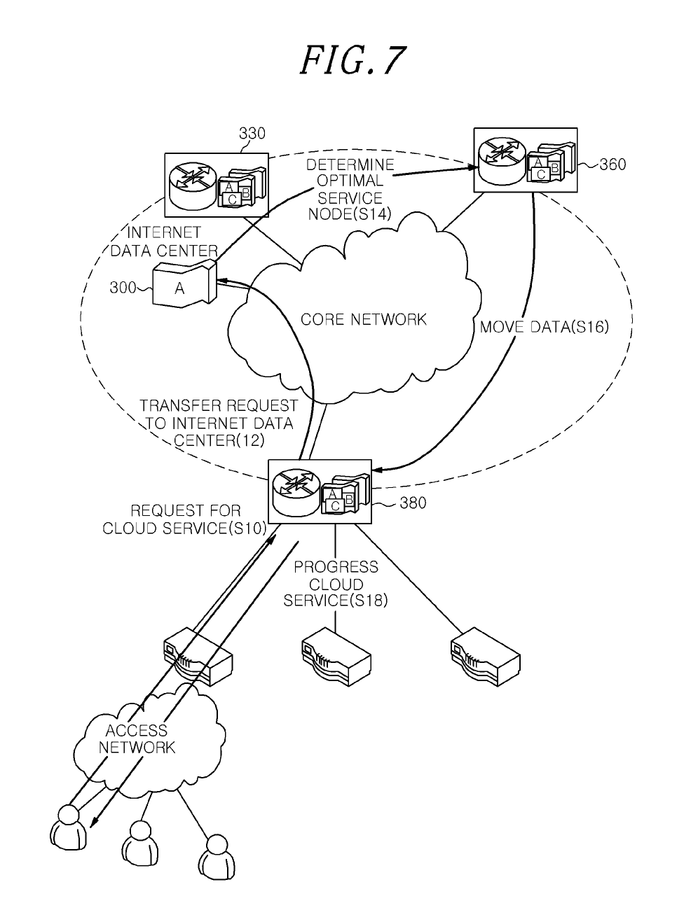

FIG. 7 shows a signal processing flow on a process of supporting the cloud service through the interaction with the IDC of the converged communication apparatus.

In FIG. 7, for example, upon a receipt of a request for a cloud service, a converged communication apparatus 380 transfers the request to the IDC 300, and a cloud service will be provided through the converged communication apparatus 360 of a computing function embedded communication node that is designated by the IDC 300.

Hereinafter, the embodiment of the embodiment of the present invention will be described in detail.

First, upon receiving a request for a cloud service from a user or a user terminal 700 in block S10, the converged communication apparatus 380 transfers the cloud service request to the IDC 300 in block S12.

Next, in block S14, the IDC 300 determines that the converged communication apparatus 360 is optimal for providing the cloud service and forwards the cloud service request to the converged communication apparatus 360.

The converged communication apparatus 360 then searches and transmits the resource corresponding to the cloud service request to the converged communication apparatus 380 that is near to a place where the user 700 connects to the core network in block S16.

Subsequently, the converged communication apparatus 380 near to the user 700 receives the resource necessary for the cloud service and deliveries the resource to the user for the provision of the cloud service in block S18.

Meanwhile, if the content necessary for the cloud service is present in the IDC 300, the content is moved from the converged communication apparatus 300 to the converged communication apparatus 380 to which the user is connected so that the cloud service can be provided. If the converged communication apparatus 380 that is optimal for providing the cloud service is located near to a place where the user 700 connects to the core network, the cloud service may be provided without the movement of data.

Alternatively, the cloud service may be conducted using the content contained in the converged communication apparatus 380 which receives a request for a cloud service. In this case, it is preferred to consider the synchronization between the IDC 300 and the external storage.

As described above, the embodiment of the present invention supports the cloud service of several service providers using the single node which interacts with the communication node and the IDC. Accordingly, it is possible to smoothly support the cloud service of the service providers and to easily provide the cloud service using the converged communication apparatus that is available in easy without additionally building up or supplementing a new physical environment.

While the description of the present invention has been made to the exemplary embodiments, various changes and modifications may be made without departing from the scope of the invention. The embodiment of the present invention is not limited thereto. Therefore, the scope of the present invention should be defined by the appended claims rather than by the foregoing embodiments.

What is claimed is:

1. A communication system for supporting a cloud service comprising:
a communication node connected to a network;
an IDC connected to the network; and
a converged communication apparatus connected to the network and configured to interact with the IDC to integrally manage a resource stored in the IDC, and, upon a receipt of a request for the cloud service, to interact with the communication node to transfer the resource to a user who makes the cloud service request or a service provider which makes the cloud service request.

2. A converged communication apparatus for supporting a cloud service comprising:
a network connectivity device configured to interact with an IDC and a plurality of communication nodes on a network to transfer data necessary for the cloud service; and
a local data center connected to the network through eh network connectivity device and configured to interact with the IDC to integrally manage a resource stored in the IDC, and, upon a receipt of a request for the cloud service, to transfer the resource corresponding to the cloud service request to a user who makes the cloud service request or a service provider which makes the cloud service request through the network connectivity device.

3. The converged communication apparatus of claim 2, wherein the local data center comprises:
a virtual server of a service provider configured to provide the cloud service using the resource to the user connected to the network; and
a storage that stores the resource necessary for the cloud service.

4. The converged communication apparatus of claim 3, wherein the virtual server comprises:
a combined resource virtualization unit configured to virtual the resource stored in the IDC;
a service provider management unit configured to perform a control and management on a service provider basis on the virtualized resource; and
a service broker unit configured to interact with the IDC and the communication node to relay the cloud service of the resource.

5. The converged communication apparatus of claim 2, wherein the resource includes a multimedia content.

6. The converged communication apparatus of claim 2, wherein the network connectivity device includes a router or a switch.

7. A method for supporting a cloud service comprising:
interacting with an IDC and a plurality of communication nodes on a network to receive a request for a cloud service;
interacting with the IDC to integrally manage a resource stored in the IDC; and,
upon a receipt of the request for the cloud service through the network, transferring the resource corresponding to the cloud service request to a user who makes the cloud service request or a service provider which makes the cloud service request through the network.

8. The method of claim 7, wherein said interacting with the IDC to integrally manage resource comprises:
virtualizing the resource stored in the IDC;
performing a control and management on a service provider basis on the virtualized resource; and
interacting with the IDC and the communication nodes to relay the cloud service of the resource.

9. A method for supporting a cloud service comprising:
receiving a request for the cloud service through a communication node on a wire/wireless network; and
transferring the cloud service request to an IDC which is connected to the network and used to provide the cloud service;
transferring the cloud service request to a converged communication unit which manages the resource and is optimal for performing the cloud service request; and
transmitting the resource corresponding to the cloud service request to a user who makes the cloud service request or a service provider which makes the cloud service request.
